(19) United States
(12) Patent Application Publication
(10) Pub. No.: US 2006/0210246 A1
(43) Pub. Date: Sep. 21, 2006

(54) Data processing apparatus

(76) Inventors: Osamu Okauchi, Hirakata-shi (JP); Kazuhiko Nakamura, Hirakata-shi (JP); Masanori Ito, Moriguchi-shi (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/549,104

(22) PCT Filed: Mar. 19, 2004
(86) PCT No.: PCT/JP04/03798

§ 371 Date: Sep. 13, 2005

(30) Foreign Application Priority Data
Mar. 27, 2003 (JP) 2003088453

(51) Int. Cl. H04N 7/00

(52) U.S. Cl. 386/95

(57) ABSTRACT

A data processor includes: a first receiving section for receiving a first signal to acquire a first data file including a first data and a first piece of related information showing contents thereof; a second receiving section for receiving a second signal; a data generating section for generating a second data based on the second signal; a processing section for generating link information showing a location of the first piece of related information, in response to the first signal and for generating a second piece of related information, showing contents thereof, in response to the second signal; a decision section for generating a different piece of decision information according to a type of the signal received; a management file generating section for generating a management file, including the decision information and the link information, for the first data; and a writing section for writing the management file and either the first data file or a second data file on the storage medium. The second data file includes the second piece of related information and the second data.

### TECHNICAL FIELD

The present invention relates to the technology of receiving a digital or analog signal concerning video and audio and storing data about the signal on a storage medium such as an optical disk. The present invention also relates to the technology of reading the data from the storage medium and playing back the video and audio.

### BACKGROUND ART

Recently, storage capacities of storage media for storing computer data or audiovisual data have been rapidly increasing. For example, a conventional rewritable optical disk has a capacity of about 650 MB, while phase change disks such as a DVD-RAM that have become more and more popular these days have a capacity of several GB. Meanwhile, semiconductor storage media (such as memory cards) with a capacity of several GB have also been put on the market.

As the capacities of the storage media and the compression coding rate of video and audio data have been increased significantly in this manner, there have been more and more opportunities to record multiple types of content data (e.g., still picture, moving picture and music data) on the same storage medium. That is why the techniques of checking out those recorded contents easily are now in high demand.

The technique of presenting thumbnail pictures on a TV screen or on the monitor attached to an appliance is well known as a method for checking out the contents easily. In fact, this technique has been adopted in digital still cameras (DSCs) and various other imagers. The “thumbnail picture” is a smaller-size version of a still picture that is stored in a semiconductor memory card, for example. The user can take a quick look at still pictures that are currently stored in a storage medium by checking out a number of thumbnail pictures presented and can select any desired one of those thumbnail pictures and have it presented as its original still picture in full scales.

To present those thumbnail pictures quickly by simple processing, Design Rule for Camera File System (DCF) standard, which defines a data structure for recording still picture data, and other standards were set up recently and have been adopted more and more broadly in DSCs and so on. Still picture data that has been recorded so as to comply with the DCF standard is called a “DCF object”.

The DCF object is a group of files that have been recorded in compliance with the DCF standard and includes a DCF basic file, a DCF expanded image file, a DCF thumbnail file and so on.

The DCF basic file is an image file including a DCF file name and an extension JPEG. And the DCF basic file 70 complies with the Exif standard and has a data structure defined by the DCF standard. FIG. 7 shows the data structure of the DCF basic file 70. The DCF basic file 70 includes APP1 (Application Data Segment 1) 71 and still picture data 73. A start code SOI (Start Of Image) is added to the top of the file and an end code EOI (End Of Image) is added to the end of the file. The APP1 71 has a maximum size of 64 KB (except an APP1 marker of 2 bytes). The APP1 (Application Data Segment 1) has information about a still picture (described in compliance with the Exif standard) and thumbnail data 72. This thumbnail data 72 is data representing a thumbnail picture of the still picture data 73.

On the other hand, the DCF expanded image file has the same file name as the DCF basic file 70 but has a different extension and a different data structure from those of the DCF basic file 70. Also, the DCF thumbnail file is a compressed file for storing thumbnails of the DCF expanded image file.

According to the DCF standard, not all files have to be stored in the same group. That is why if no DCF thumbnail files are stored, then the thumbnail data 72 needs to be read out from each DCF basic file 70. Also, the DCF standard is a standard about still pictures and includes no definitions on the data structures of moving pictures.

In view of these considerations, Japanese Patent Application Laid-Open Publication No. 2000-236496 discloses the technique of storing content related information, including thumbnail data of still and moving pictures, as a management file on a storage medium separately from the DCF basic file 70 and so on. The thumbnail pictures are presented in accordance with that management file. This technique can cope with a situation where moving picture data and still picture data are stored on the same storage medium. Also, by reading only the management information intensively, the presentation of the thumbnail pictures can be speeded up.

According to this technique, however, the storage area is limited excessively. This is because not only the DCF basic file 70 including the thumbnail data 72 but also management information including equivalent thumbnail data need to be separately stored as well. Among other things, to ensure the compatibility of the still picture data and to make that data transferable to any other type of storage medium, the same thumbnail data as the counterpart 72 that has a format compliant with the DCF standard is preferably copied and included in the management information. In that case, however, the thumbnail data 72 with quite the same contents is stored separately, thus limiting the storage capacity more than necessarily. More particularly, the DCF standard defines that the APP1 71 including the thumbnail data have a data size of 64 KB or less. Accordingly, supposing there are 100 still picture files, an area of 64 MB may be wasted in a worst-case scenario. Then, a storage medium with a huge storage capacity cannot be used effectively enough.

Thus, an object of the present invention is to make related information about the contents of a given content (such as thumbnail picture data) quickly accessible by simple processing and to provide a data structure that can minimize the waste of storage capacity.

### DISCLOSURE OF INVENTION

A data processor according to the present invention includes: a first receiving section for receiving a first signal to acquire a first data file including a first data concerning video and/or audio and a first piece of related information showing contents of the first data; a second receiving section for receiving a second signal representing video and/or audio; a data generating section for generating a second data concerning the video and/or the audio based on the second signal; a processing section for generating link information showing a location of the first piece of related information in the first data file, in response to the first signal and for generating a second piece of related information, showing contents of the second data, in response to the second signal; a decision section for generating a different piece of decision information according to a type of the signal received; a management file generating section for generating a management file, including the decision information and the link information, for the first data; and a writing section for writing the management file on a storage medium and also writing either the first data file or a second data file on the storage medium, the second data file including the second piece of related information and the second data.

The decision section may generate a different piece of decision information depending on whether the signal received is the first signal or the second signal. The management file generating section may generate a management file, including the decision information and the second piece of related information, for the second data, when the decision information shows that the received signal is the second signal, and the writing section may write the management file on the storage medium.

The processing section may generate, as the link information, at least one of information identifying the first data file, an offset from the top of the first data file to the first piece of related information, and the size of the first piece of related information.

The first receiving section may acquire the first data concerning the video and the first piece of related information, including thumbnail data of the video, based on the first data file.

The first receiving section may acquire, based on the first data file, either the first data concerning a still picture and the first piece of related information, including thumbnail data of the still picture, or the first data concerning a moving picture and the first piece of related information including thumbnail data of one picture of the moving picture.

The second receiving section may receive the second signal representing the video and the processing section may generate the second piece of related information including thumbnail data of the video.

The processing section may generate either the second piece of related information including thumbnail data of a still picture or the second piece of related information including thumbnail data of one picture of a moving picture.

The first receiving section may acquire the first data concerning the audio and the first piece of related information including thumbnail data showing identity as audio based on the first data file.

A data processing method according to the present invention includes the steps of: receiving a first signal to acquire a first data file including a first data concerning video and/or audio and a first piece of related information showing contents of the first data; receiving a second signal representing video and/or audio; generating a second data concerning the video and/or the audio based on the second signal; generating link information, showing a location of the first piece of related information in the first data file, in response to the first signal and generating a second piece of related information, showing contents of the second data, in response to the second signal; generating a different piece of decision information according to a type of the signal received; generating a management file, including the decision information and the link information, for the first data; and writing the management file on a storage medium and also writing either the first data file or a second data file on the storage medium, the second data file including the second piece of related information and the second data.

The step of generating the decision information may include generating a different piece of decision information depending on whether the signal received is the first signal or the second signal. The step of generating the management file may include generating a management file, including the decision information and the second piece of related information, for the second data, when the decision information shows that the received signal is the second signal, and the step of writing may include writing the management file on the storage medium.

The step of generating the second piece of related information may include generating, as the link information, at least one of information identifying the first data file, an offset from the top of the first data file to the first piece of related information, and the size of the first piece of related information.

The step of acquiring the first data file may include acquiring the first data concerning the video and the first piece of related information, including thumbnail data of the video, based on the first data file.

The step of acquiring the first data file may include acquiring, based on the first data file, either the first data concerning a still picture and the first piece of related information, including thumbnail data of the still picture, or the first data concerning a moving picture and the first piece of related information including thumbnail data of one picture of the moving picture.

The step of receiving the second signal may include receiving the second signal representing the video and the step of generating the second piece of related information may include generating the second piece of related information including thumbnail data of the video.

The step of generating the second piece of related information may include generating either the second piece of related information including thumbnail data of a still picture or the second piece of related information including thumbnail data of one picture of a moving picture.

The step of acquiring the first data file may include acquiring the first data concerning the audio and the first piece of related information, including thumbnail data showing identity as audio based on the first data file.

A data processing program according to the present invention is executable by a computer. Following this program, a data processor, including a built-in computer, performs the steps of: receiving a first signal to acquire a first data file including a first data concerning video and/or audio and a first piece of related information showing contents of the first data; receiving a second signal that is a video signal and/or an audio signal; generating a second data concerning the video and/or the audio based on the second signal; generating link information, showing a location of the first piece of related information in the first data file, in response to the first signal and generating a second piece of related information, showing contents of the second data, in response to the second signal; generating a different piece of decision information according to a type of the signal received; generating a management file, including the decision information and the link information, for the first data; and writing the management file on a storage medium and also writing either the first data file or a second data file on the storage medium, the second data file including the second piece of related information and the second data.

Another data processor according to the present invention includes: a first receiving section for receiving a first signal to acquire a first data file including a first data concerning video and/or audio and a first piece of related information showing contents of the first data; a second receiving section for receiving a second signal representing video and/or audio; a data generating section for generating a second data concerning the video and/or the audio based on the second signal; a processing section, which generates a second piece of related information, showing contents of the second data, in response to the second signal and also generates link information, showing a location of the related information, according to amount of present one of the first and second pieces of related information; a decision section for generating decision information according to the amount of the related information; a management file generating section for generating a management file including the decision information and the link information, when the link information has been generated or generating a management file including the decision information and the related information, unless the link information has been generated; and a writing section for writing the management file on a storage medium and also writing either the first data file or a second data file, including the second piece of related information and the second data, on the storage medium.

If the received signal is the first signal, the decision section generates a different piece of decision information depending on whether or not the amount of the first piece of related information is equal to or less than a predetermined value. If the value of the decision information shows that the amount of the first piece of related information is equal to or less than the predetermined value, the management file generating section may generate a management file, including the decision information and the first piece of related information, for the first data. On the other hand, if the value of the decision information shows that the amount of the first piece of related information is greater than the predetermined value, the processing section may further generate link information showing the location of the first piece of related information. The management file generating section may generate a management file, including the decision information and the link information, for the first data and the writing section may write the management file on the storage medium.

If the received signal is the second signal, the decision section generates a different piece of decision information depending on whether or not the amount of the second piece of related information is equal to or less than a predetermined value. If the value of the decision information shows that the amount of the second piece of related information is equal to or less than the predetermined value, the management file generating section may generate a management file, including the decision information and the second piece of related information, for the second data. On the other hand, if the value of the decision information shows that the amount of the second piece of related information is greater than the predetermined value, the processing section may further generate link information showing the location of the second piece of related information. The management file generating section may generate a management file, including the decision information and the link information, for the second data and the writing section may write the management file on the storage medium.

Another data processing method according to the present invention includes the steps of: receiving a first signal and acquiring a first data file including a first data concerning video and/or audio and a first piece of related information showing the contents of the first data or receiving a second signal representing video and/or audio; generating a second data concerning the video and/or the audio based on the second signal if the second signal has been received; generating a second piece of related information, showing the contents of the second data, in response to the second signal and also generating link information, showing the location of the related information, according to the amount of present one of the first and second pieces of related information; generating decision information according to the amount of the related information; generating a management file, including the decision information and the link information, if the link information has been generated or a management file, including the decision information and the related information, unless the link information has been generated; and writing the management file on a storage medium and also writing either the first data file or a second data file, including the second piece of related information and the second data, on the storage medium.

If the received signal is the first signal, the step of generating the decision information includes generating a different piece of decision information depending on whether or not the amount of the first piece of related information is equal to or less than a predetermined value. If the value of the decision information shows that the amount of the first piece of related information is equal to or less than the predetermined value, the step of generating the management file may include generating a management file, including the decision information and the first piece of related information, for the first data. On the other hand, if the value of the decision information shows that the amount of the first piece of related information is greater than the predetermined value, the method may further include the step of generating link information showing the location of the first piece of related information. The step of generating the management file may include the step of generating a management file, including the decision information and the link information, for the first data and the step of writing may include writing the management file on the storage medium.

If the received signal is the second signal, the step of generating the decision information includes generating a different piece of decision information depending on whether or not the amount of the second piece of related information is equal to or less than a predetermined value. If the value of the decision information shows that the amount of the second piece of related information is equal to or less than the predetermined value, the step of generating the management file may include generating a management file, including the decision information and the second piece of related information, for the second data. On the other hand, if the value of the decision information shows that the amount of the second piece of related information is greater than the predetermined value, the method may further include the step of generating link information showing the location of the second piece of related information. The step of generating the management file may include the step of generating a management file, including the decision information and the link information, for the second data and the step of writing may include writing the management file on the storage medium.

Another data processing program according to the present invention is executable by a computer. Following this program, a data processor, including a built-in computer, performs the steps of: receiving a first signal to acquire a first data file including a first data concerning video and/or audio and a first piece of related information showing contents of the first data or receiving a second signal representing video and/or audio; generating a second data concerning the video and/or the audio based on the second signal if the second signal has been received; generating a second piece of related information showing the contents of the second data, in response to the second signal and also generating link information showing a location of the related information, according to the amount of present one of the first and second pieces of related information; generating decision information according to the amount of the related information; generating a management file, including the decision information and the link information, if the link information has been generated or a management file, including the decision information and the related information, unless the link information has been generated; and writing the management file on a storage medium and also writing either the first data file or a second data file including the second piece of related information and the second data, on the storage medium.

### BRIEF DESCRIPTION OF DRAWINGS

FIG. 1 shows an arrangement of functional blocks for a data processor 10 according to a first preferred embodiment.

FIG. 2 is a flowchart showing the procedure of recording processing to be done by the data processor 10 of the first preferred embodiment.

FIG. 3 shows a relationship between various files that have been written on an optical disk 131.

FIG. 4(a) shows the data structures of thumbnail information #0 and still picture data file #0 that have no links.

FIG. 4(b) shows the data structures of thumbnail information #1 and still picture data file #1 that do have a link.

FIG. 5 is a flowchart showing the procedure of playback processing to be done by the data processor 10.

FIG. 6 is a flowchart showing the procedure of recording processing to be done by a data processor 10 according to a second preferred embodiment.

FIG. 7 shows the data structure of a DCF basic file 70.

### BEST MODE FOR CARRYING OUT THE INVENTION

Hereinafter, first and second specific preferred embodiments of the present invention will be described with reference to the accompanying drawings.

### Embodiment 1

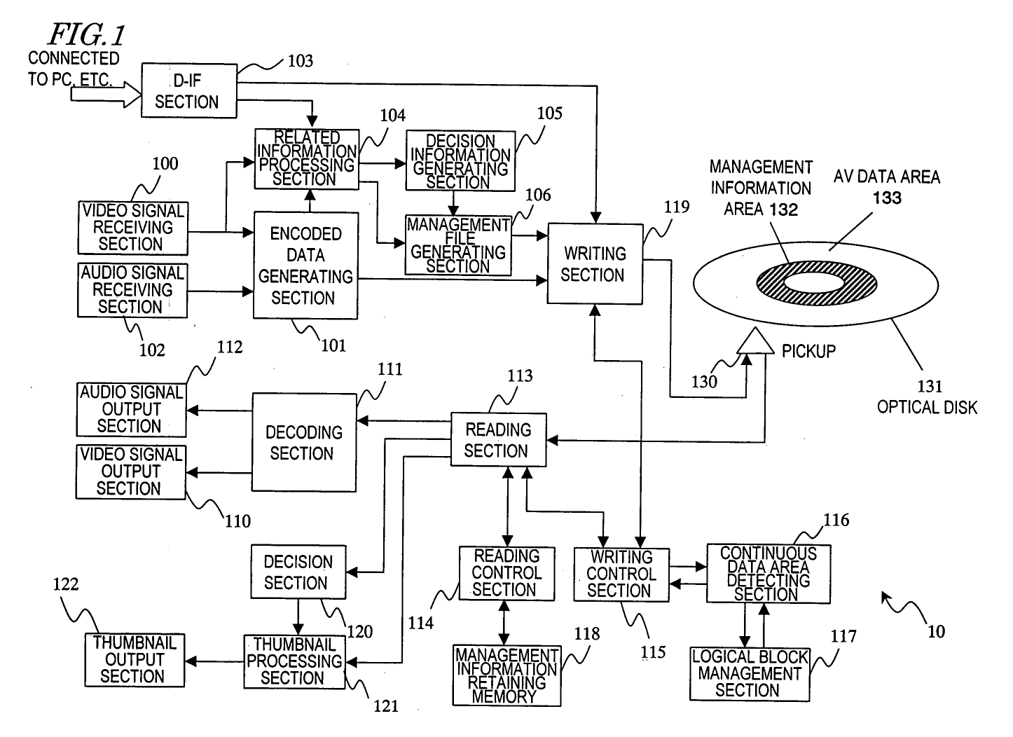

FIG. 1 shows an arrangement of functional blocks for a data processor 10 according to a first preferred embodiment. The data processor 10 has functions of recording and playing data. More particularly, the data processor 10 has a recording function to be realized by receiving a digital or analog signal concerning video and/or audio and writing data, extracted from the signal, on a storage medium (e.g., an optical disk in this example) 131. This data includes not only substantive data obtained by compressing and encoding the video and/or audio but also related information showing contents of the video and/or audio and link information for gaining access to the related information included in the substantive data. Meanwhile, the data processor 10 also has a playback function of reading the data from the optical disk 131 and playing back the video and/or audio. For example, the data processor 10 reads out the related information mentioned above and outputs thumbnail pictures showing the contents of the video and/or audio based on the related information.

The optical disk 131 is not an essential component for the data processor 10 but is shown in FIG. 1 for convenience sake. The data processor 10 is actually made up of the other components shown in FIG. 1. As to optical disks 131, there are various standards. Among those standards, DVD-RAM disks, MOs, DVD-Rs, DVD-RWs, +RWs, CD-Rs and CD-RWs are well known. It should be noted that the storage medium may be a removable storage medium other than the optical disk 131 (e.g., a semiconductor memory card) and may also be a hard disk, a semiconductor memory or any other component that forms an integral part of the data processor 10.

Hereinafter, respective components for realizing the recording function of the data processor 10 and then the recording processing thereof will be described. After that, respective components for realizing the playback function of the data processor 10 and then the playback processing thereof will be described.

First, those components of the data processor 10 for realizing the recording function thereof will be described. The data processor 10 includes a video signal receiving section 100, an encoded data generating section 101, an audio signal receiving section 102, a digital interface section 103, a related information processing section 104, a decision information generating section 105, a management file generating section 106, a writing control section 115, a continuous data area detecting section 116, a block management section 117, a writing section 119 and an optical pickup 130.

The video signal receiving section 100 receives a video signal. The video signal may be a digital signal representing a still picture or a moving picture, which has been supplied from the imager (CCD) of a digital still camera, or an analog signal of a televised wave, for example. The audio signal receiving section 102 receives an audio signal concerning audio. The audio signal may be a signal output from a microphone while a moving picture is being taken, for example. It should be noted that both the video signal and audio signal will be regarded as signals in an analog format that have not been digitally compressed and encoded. This assumption is made to avoid unnecessary confusion because the signal supplied from the digital interface section 103 is a digital signal as will be described later. The following statement applies in quite the same way to even a situation where the video signal is a digital signal supplied from the CCD of a digital still camera.

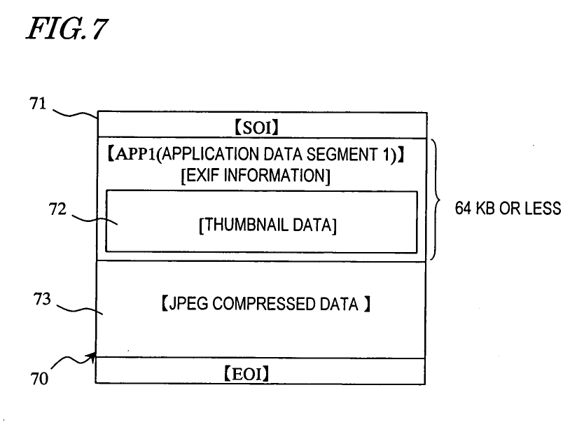

The encoded data generating section 101 compresses and encodes the audiovisual data extracted from the video signal and audio signal. For example, if the video is a still picture, the encoded data generating section 101 compresses and encodes the video data in compliance with the JPEG standard, thereby obtaining a DCF file compliant with the DCF standard. An exemplary data structure of the DCF file is as shown in FIG. 7. Meanwhile, if the video is a moving picture, then the encoded data generating section 101 compresses and encodes the moving picture in compliance with an MPEG standard, thereby obtaining an MPEG file. Also, the encoded data generating section 101 compresses and encodes the audio data in the AC3 format.

The digital interface section 103 (which will be referred to herein as a “D-IF section 103”) is connected to an external unit and receives a digital signal from the unit, thereby acquiring a file of digital data. The “external appliance” may be a PC (personal computer) or a general-purpose drive, for example. The D-IF section 103 acquires a still picture data file in the DCF format for a still picture, an MPEG data file for a moving picture, and an AC3 data file for audio, respectively. The D-IF section 103 is a digital interface such as an IEEE 1394 interface or a USB (universal serial bus) interface.

The data file obtained through the D-IF section 103 includes related information that shows the contents of that data. For example, the related information showing the contents of a still picture includes data representing a thumbnail picture of that still picture. As to the MPEG data and AC3 data, related information, including a thumbnail picture showing its contents, is also described. These pieces of related information are generated by an external unit other than the data processor 10 (e.g., the unit connected to the D-IF section 103) and described in the data file.

As the encoded data is generated, the related information processing section 104 performs the processing of generating or extracting the related information showing the contents of that encoded data. As to the video data obtained by way of the video signal receiving section 100, the related information processing section 104 generates thumbnail pictures, recording date and time, and the name of the recorder as pieces of related information. If the original video is a still picture, then the thumbnail picture is generated as a smaller-size version of that still picture. On the other hand, if the original video is a moving picture, then the thumbnail picture is generated as a smaller-size version of one picture (i.e., one frame or one field) of the moving picture. Meanwhile, as to the video data obtained through the D-IF section 103, the related information processing section 104 extracts, as the related information, the APP1 71 including the thumbnail data 72 that is stored in the DCF file. The same statement as the video data applies to the audio data, too. The thumbnail picture data may be generated in the JPEG format, for example, inside the processor. A thumbnail picture for audio data is a picture characterizing that audio.

As to audio data on the other hand, the related information processing section 104 generates or extracts data showing the characteristic as audio (e.g., data about the title or player, icon data representing a musical note, or user defined picture data). These types of picture data will also be referred to herein as “thumbnail picture data”, which is also generated in the JPEG format.

The decision information generating section 105 generates information to determine whether the related information has been generated by the encoded data generating section 101 of the data processor 10 or extracted from a file that has been input through the D-IF section 103. In this description, the decision information generating section 105 generates decision information, of which the value changes depending on whether an analog signal has been input through the video signal receiving section 100 and/or the audio signal receiving section 102 or a digital signal has been input through the D-IF section 103. More specifically, the decision information generating section 105 generates decision information with a value “1” if the related information has been generated by the related information processing section 104 in the data processor 10 but generates decision information with a value “0” if the related information has been generated by an external unit.

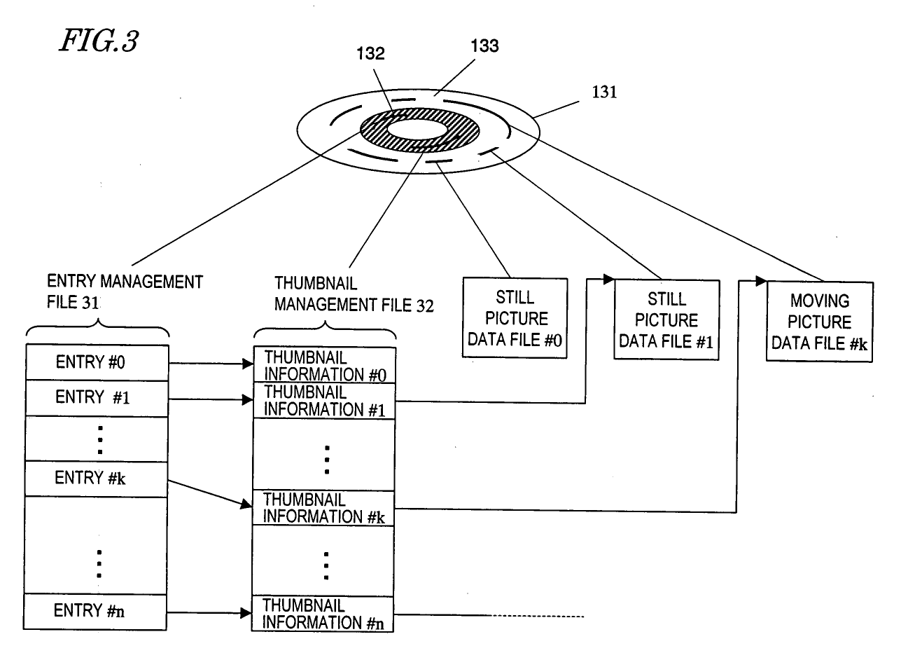

The management file generating section 106 generates an entry management file and a thumbnail management file. FIG. 3 schematically illustrates an exemplary entry management file and an exemplary thumbnail management file as will be referred to later. These files will be referred to herein as “management files” collectively.

Every time the video signal receiving section 100, audio signal receiving section 102 or D-IF section 103 receives a signal or performs recording processing, the management file generating section 106 adds an entry, specifying the processing, to the entry management file.

Also, the management file generating section 106 describes information about a thumbnail picture for each entry (i.e., thumbnail information) on the thumbnail management file.

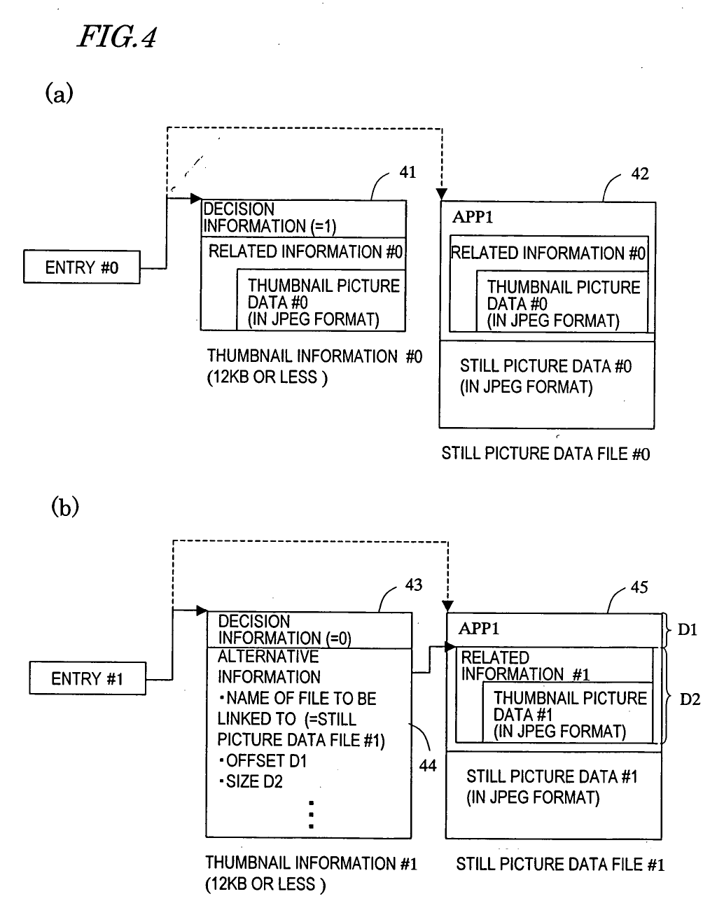

In each piece of thumbnail information, information to access the related information is described, and the decision information and information that varies with its value are described. FIGS. 4(a) and 4(b) show exemplary thumbnail information as will be described later.

First, if the decision information has a value “1∞, then the encoded data generating section 101 performs compression and encoding to generate data representing a still picture, for example. In that case, the management file generating section 106 generates decision information with the value “1” and related information including thumbnail picture data for its still picture, for example, as the thumbnail information.

On the other hand, if the decision information has a value “0”, then the D-IF section 103 has received a data file including related information and still picture data, for example. The related information includes thumbnail picture data. Thus, the management file generating section 106 generates link information that indicates the location of the thumbnail picture data. The link information includes the file name of a data file to be linked to, the data length (offset) from the top of the data file to the related information, and the amount of information (i.e., the data size) of the related information. The link information is provided as a replacement for the related information in the thumbnail information, and therefore, will sometimes be referred to herein as “alternative information”, too. It should be noted that the management file generating section 106 can acquire these types of information, no matter whether or not the data file has actually been stored on the optical disk 131 when the link information is generated. This is because it is the data processor 10 that writes this data file. Thus, the data processor 10 has already collected these pieces of information to store when generating the link information.

The writing section 119 gets the file written by the pickup 130 on the optical disk 131. This write operation is controlled by the writing control section 115. In accordance with the instruction given by the writing control section 115, the continuous data area detecting section 116 checks the availability of sectors, which are managed by the logical block management section 117, thereby detecting a physically continuous empty area available. As a result, the management file is written on a management information area 132, to which a predetermined amount of data is assigned from the inner edge of the optical disk 131, while the data file is written on an AV data area 133, which is provided outside of the management information area 132. By arranging the management file exclusively on the inside portion of the disk, faster access and quicker readout are realized.

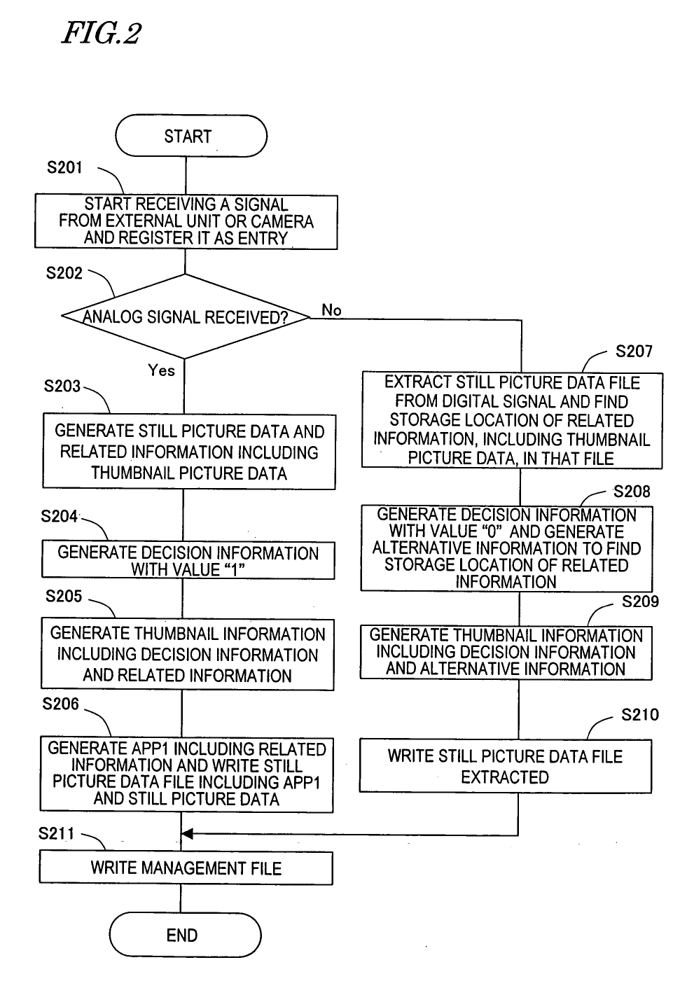

Hereinafter, it will be described with reference to FIG. 2 how the data processor 10 operates to perform its recording function. In the following example, it will be described how to process a still picture. That is to say, suppose an analog video signal representing a still picture is being input to the video signal receiving section 100 or a digital signal representing a still picture is being input to the D-IF section 103. Also, no audio signal is supposed to be input to the audio signal receiving section 102.

FIG. 2 shows a procedure of the recording processing to be done by the data processor 10 of this preferred embodiment. In Step S201, the data processor 10 starts receiving a signal from a camera at the video signal receiving section 100 and audio signal receiving section 102, or starts receiving a signal from an external unit via the D-IF section 103. The management file generating section 106 registers it as a new entry. Next, in Step S202, by finding which component received the signal, the data processor 10 determines whether the received signal is an analog signal or a digital signal. If the received signal turned out to be an analog signal, the process advances to Step S203. On the other hand, if the received signal turned out to be a digital signal, the process advances to Step S207.

In Step S203, the encoded data generating section 101 generates still picture data and the related information processing section 104 generates related information including thumbnail picture data. In the next step S204, the decision information generating section 105 generates decision information with a value “1”. In Step S205, the management file generating section 106 generates thumbnail information including decision information and related information. Then, in Step S206, under the control of the writing control section 115, the management file generating section 106 generates APP1 including the related information and the writing section 119 writes a still picture data file, including the APP1 and still picture data, on the optical disk 131. After that, the process advances to Step S211.

In Step S207 on the other hand, the D-IF section 103 extracts a still picture data file from the digital signal and the related information processing section 104 finds the storage location of the related information including the thumbnail picture data in that file. In the next step S208, the decision information generating section 105 generates decision information with a value “0”, the management file generating section 106 generates alternative information to find the storage location of the related information, and the process advances to Step S209. In Step S209, the management file generating section 106 generates thumbnail information including the decision information and alternative information and the process advances to Step S210. Then, in Step S210, under the control of the writing control section 115, the writing section 119 writes the still picture data file extracted on the optical disk 131. After that, the process advances to Step S211.

In Step S211, the writing section 119 writes the management file on the optical disk 131 under the control of the writing control section 115.

FIG. 3 shows a relationship between various files that have been written on the optical disk 131. In the management information area 132 of the optical disk 131, an entry management file 31 and a thumbnail management file 32 are stored. In the AV data area 133, still picture data files #1 and #2 and a moving picture data file #k are stored. In the entry management file 31, entries #0, #1, . . . and #n are described. In the thumbnail management file 32, thumbnail information, each piece of which has the same number as its associated entry, is stored. Each piece of thumbnail information has a data size of 12 KB or less. In FIG. 3, entry, thumbnail information and data file with the same number are supposed to be respective pieces of information about the same content.

In FIG. 3, the arrow indicates what information each piece of information refers to (i.e., is linked to). For example, if the content of entry #0 is designated, then the thumbnail information #0 is referred to in the thumbnail management file 32. In FIG. 3, there is no arrow pointing from thumbnail information #0 toward still picture data file #0, but there is an arrow pointing from thumbnail information #1 toward still picture data file #1. The presence or absence of such an arrow shows whether or not there is a link to the thumbnail picture data.

Hereinafter, the relationship between the thumbnail information and the still picture data file will be described in detail with reference to FIGS. 4(a) and 4(b). The thumbnail information #0 and #1 shown in FIG. 3 will be taken as an example.

FIG. 4(a) shows the data structures of thumbnail information #0 and still picture data file #0 that have no links between themselves. This data structure shows that the encoded data generating section 101 generated the still picture data #0. The thumbnail information #0 includes decision information 41 with a value “1” and related information #0. The related information #0 includes thumbnail picture data #0 in the JPEG format. The contents of this related information #0 are the same as those of the related information #0 stored in the APP1 42 of its associated still picture data file #0. In playing back a thumbnail picture, its picture data can be obtained by referring to the thumbnail information, and there is no need to read or analyze the still picture data file #0.

The related information #0 including the thumbnail picture data #0 is stored in both the thumbnail information #0 and the still picture data file #0 alike. Thus, the storage capacity of the optical disk 131 seems to be wasted in vain. In FIG. 4(a), however, the related information processing section 104 generates each piece of thumbnail information with its data size limited to 12 KB or less. Accordingly, even if the related information #0 were copied and used as the related information #0 of the still picture data file #0, the APP1 42 of the still picture data file #0 could still meet the limit of 64 KB or less as defined by the DCF standard. In addition, the data size of each piece of thumbnail information is limited to 12 KB or less, which is about one-fifth of the maximum permissible data size of 64 KB as defined by the DCF standard, and therefore, the redundancy can be cut down significantly. Consequently, compared to the prior art, the storage area of the storage medium can be regarded as being used much more effectively.

FIG. 4(b) shows the data structures of thumbnail information #1 and still picture data file #1 that do have a link between themselves. This data structure shows that the D-IF section 103 acquired still picture data file #1 including related information #1 and still picture data #1. The thumbnail information #1 includes decision information 43 with a value “0” and alternative information 44. No thumbnail picture data is included in the alternative information 44 but instead link information, showing the location of the related information #1 in the still picture data file #1, is described there. Supposing the still picture data file #1 consists of APP1 45 and still picture data #1, the link information includes information to designate the still picture data file #1 (i.e., its file name), the offset D1 from the top of the still picture data file #1 to the related information #1, and information about the data size D2 of the related information #1. In playing back the thumbnail picture, the related information #1 in the still picture data file #1 is located by the link information and the thumbnail picture data #1 can be read out therefrom.

According to the alternative information 44 shown in FIG. 4(b), the thumbnail information #1 includes link information that makes it possible to access the thumbnail picture data #1 of the related information #1 stored in the still picture data file #1 without storing the thumbnail picture data #1 separately. Thus, compared to the prior art in which thumbnail picture data is always stored in both the management file and data file alike, the redundancy of the contents of the storage medium can be cut down significantly.

Furthermore, according to this preferred embodiment, even if the related information of a data file is included in the APP1 42 but if it would take a lot of time to analyze it because the size of the related information is unknown due to the processing by an external unit or because its contents cannot be known unless the data is analyzed, just link information needs to be generated to access that related information. As a result, the processing can be done much more quickly. In addition, the data size of the thumbnail information is limited to 12 KB or less, thereby using the storage area of the storage medium far more effectively than in the prior art.

Optionally, a uniform resource locator (URL) may be described as the alternative information. In that case, in playing back video or audio on a personal computer (PC) or any other device that is connected to the Internet, thumbnail picture data can be acquired from the website located by the URL. Also, if a URL is described as a part of the related information, not only the thumbnail picture data but also information designated by the URL can be used as well.

It should be noted that a start of image (SOI) code and an end of image (EOI) code are actually respectively added to the top and the end of each still picture data file shown in FIGS. 4(a) and 4(b) but are not shown there.

Next, respective components of the data processor 10, which perform its reading function, will be described with reference to FIG. 1 again. The data processor 10 includes a video signal output section 110, a decoding section 111, an audio signal output section 112, a reading section 113, a reading control section 114, a management information retaining memory 118, a decision section 120, a thumbnail processing section 121 and a thumbnail output section 122.

The reading section 113 gets the data on the optical disk 131 read by the pickup 130 and acquires it as digital data. This read operation is carried out in accordance with the instruction of the reading control section 114. Before giving the instruction to read that data, the reading control section 114 instructs the reading section 113 to read the entry management file 31 from the management information area 132 of the optical disk 131. The management information retaining memory 118 retains the management file that has been read. After having been instructed to read the data, the reading section 113 reads the thumbnail management file 32 and data file, associated with the entry specified, from the management information area 132.

The decoding section 111 receives the compressed and encoded video and/or audio data and performs a decoding process thereon according to the compression format, thereby outputting video data and/or audio data. In response, the video signal output section 110 and audio signal output section 112 output the decoded video signal and/or audio signal, respectively, to a TV and a loudspeaker, for example.

The decision section 120 reads thumbnail information, associated with the entry that has been designated by the user in the thumbnail management file 32, from the management information retaining memory 118. And based on the decision information in the thumbnail information, the decision section 120 determines whether the thumbnail information includes the related information or alternative information. As shown in FIGS. 4(a) and 4(b), if the decision information has a value “1”, the related information is included in the thumbnail information. On the other hand, if the decision information has a value “0”, then the alternative information is included in the thumbnail information.

Following the decision made by the decision section 120, if the related information is included in the thumbnail information, the thumbnail processing section 121 reads that related information. On the other hand, if the alternative information is included in the thumbnail information, the thumbnail processing section 121 reads the related information from the data file according to the contents of the alternative information. Then, the thumbnail processing section 121 extracts the thumbnail picture data from the related information and outputs it. In response, the thumbnail output section 122 outputs that thumbnail picture data to a TV or an LCD (not shown) attached to the data processor 10, for example.

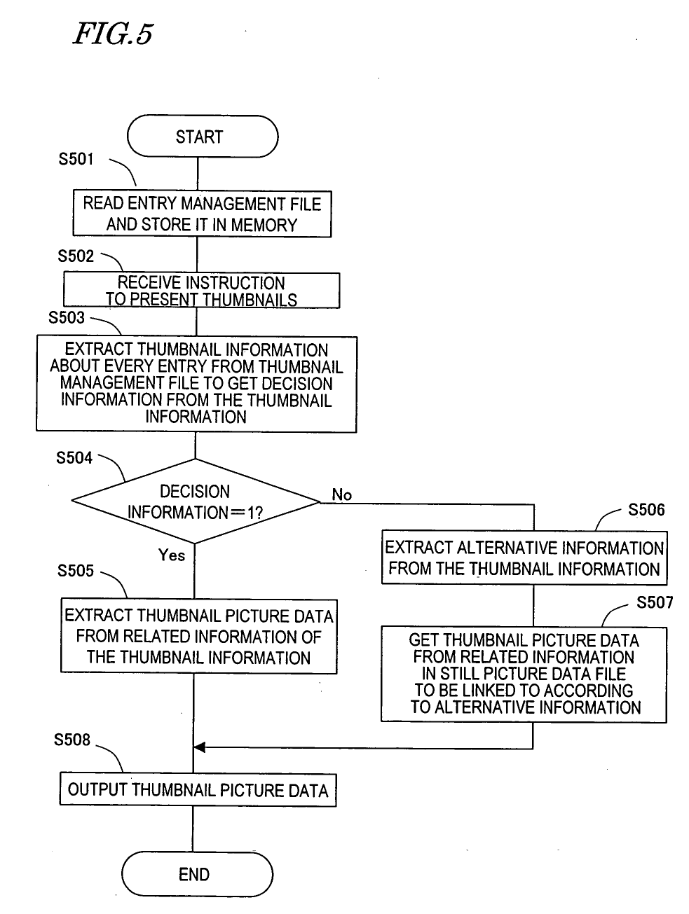

Hereinafter, it will be described how the data processor 10 performs its playback operation. In the following example, the processing of playing back a thumbnail picture will be described. FIG. 5 shows the procedure of playback processing to be done by the data processor 10. First, in Step S501, the reading control section 114 gets the entry management file 31 read by the reading section 113 and pickup 130 and stores it in the management information retaining memory 118. Next, in Step S502, the reading control section 114 receives an instruction to present thumbnails from the user by way of a remote controller (not shown). In the following description, the “instruction to present thumbnails” is supposed herein to be an instruction to get a plurality of thumbnail pictures presented to show a list of still pictures, moving pictures, music and so on that are stored on the optical disk 131.

Next, in Step S503, the reading control section 114 reads the thumbnail management file 32 and extracts thumbnail information about every entry of the entry management file 31 from the thumbnail management file 32, thereby getting the decision information from the thumbnail information. As can be seen easily from the thumbnail management file 32 shown in FIG. 3, the thumbnail information is arranged continuously, and can be read quickly and efficiently. In this example, the reading control section 114 is supposed to extract the thumbnail information about all entries. However, this is just an example, and any arbitrary number of information items may be extracted. That is to say, not all but a required number of thumbnail information items may be extracted according to the memory capacity, read time and other factors.

Next, in Step S504, the decision section 120 determines whether or not the decision information has a value “1”. If the answer is YES, the process advances to Step S505. Otherwise, the process advances to Step S506.

In Step S505, the thumbnail processing section 121 extracts the thumbnail picture data from the related information of the thumbnail information. Meanwhile, in Step S506, the thumbnail processing section 121 extracts the alternative information from the thumbnail information. Then, in Step S507, the thumbnail processing section 121 gets the thumbnail picture data from the related information in the still picture data file that can be linked to according to the alternative information.

Next, in Step S508, the thumbnail output section 122 outputs the thumbnail picture data obtained. By performing these processing steps, a list of thumbnails is presented.

In the processing described above, the data to be referred to is pointed by the solid arrows in FIGS. 4(a) and 4(b). On the other hand, the dashed arrows in FIGS. 4(a) and 4(b) point the data to be referred to when the user designates particular video or audio to play after taking a look at the list of thumbnail pictures, for example. For example, the dashed arrow shown in FIG. 4(a) indicates that when an instruction to present a still picture entry #0 is received from the user, the still picture data file #0 is directly referred to from the entry #0.

An example in which a thumbnail picture is presented for every entry has been described with reference to FIG. 5. However, if play list information, defining the playback order of part (or all) of still pictures and moving picture streams, is stored on the optical disk 131, then entries and thumbnail information may be extracted from the playback route defined by the play list information and the thumbnail pictures may be played back within the playback route defined by the play list information.

### Embodiment 2

A second preferred embodiment of the present invention is different from the first preferred embodiment in recording processing. Hereinafter, it will be described in what procedure the recording processing is done in this preferred embodiment. It should be noted that the data processor of this preferred embodiment basically has the same configuration as the data processor 10 of the first preferred embodiment (see FIG. 1). The functions of a number of different components will be mentioned while the procedure of the recording processing is described.

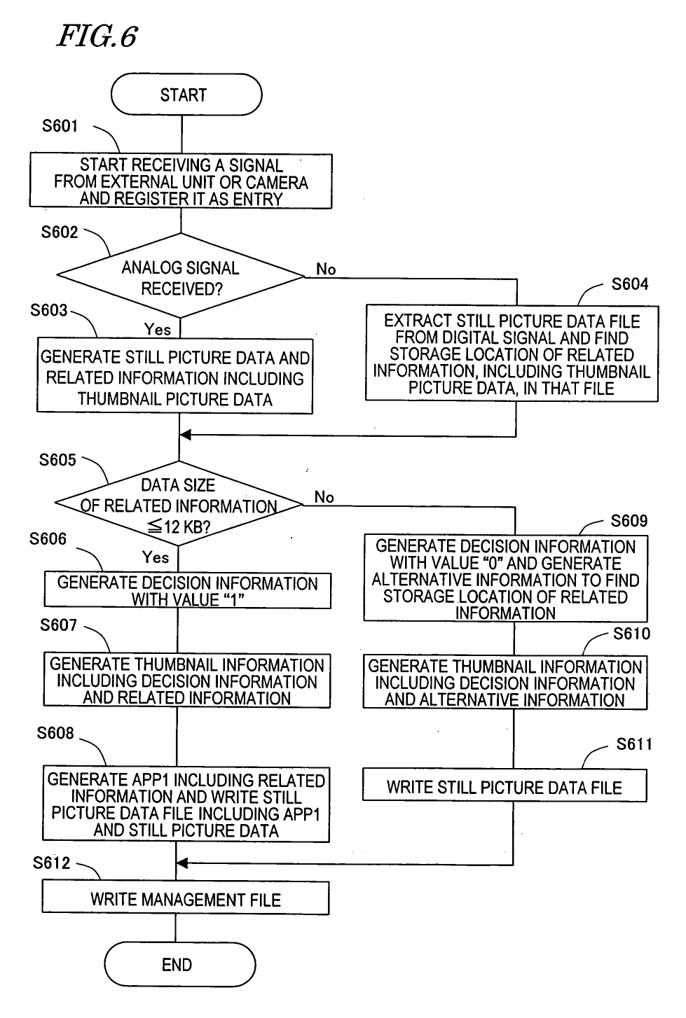

FIG. 6 shows the procedure of recording processing to be done by the data processor 10 of this preferred embodiment. In the recording processing of this preferred embodiment, the decision information generating section 105 changes the values of the decision information to generate depending on whether or not the data size of the related information described in the thumbnail information is a predetermined value (e.g., 12 KB in this preferred embodiment) or less. In the following example, it will be described how to process still picture data received as in the example described for the first preferred embodiment.

First, in Step S601, reception of a signal is started via the video signal receiving section 100 and audio signal receiving section 102 or the D-IF section 103. The management file generating section 106 registers a new entry. Next, in Step S602, by finding which component received the signal, the data processor 10 determines whether the received signal is an analog signal or a digital signal. If the received signal turned out to be an analog signal, the process advances to Step S603. On the other hand, if the received signal turned out to be a digital signal, the process advances to Step S606.

In Step S603, the encoded data generating section 101 generates still picture data and the related information processing section 104 generates related information including thumbnail picture data. In Step S604 on the other hand, the D-IF section 103 extracts a still picture data file from the digital signal and the related information processing section 104 finds the storage location of the related information including the thumbnail picture data in that file. When the processing step S603 or S604 is finished, the process advances to Step S605.

In Step S605, the decision information generating section 105 determines whether or not the related information has a data size of 12 KB or less. If the data size is 12 KB or less, the process advances to Step S606. On the other hand, if the data size is greater than 12 KB, then the process advances to Step S609. It should be noted that this “related information” includes both the related information generated in response to an analog signal received and the related information generated by an external unit in response to a digital signal received.

Generally speaking, if it is instructed that the data size of the encoded data generated be a predetermined value (i.e., 12 KB in this case) or less, then the data size can be controlled at most equal to that value by adjusting the encoding rate, for example. However, as the video compression rate depends on the complexity of video and other factors, the data size may sometimes exceed that value. That is why even if the video signal receiving section 100 or the audio signal receiving section 102 has received a signal and if the encoded data generating section 101 has compressed and encoded the data, a decision is made herein on the data size of the related information.

In Step S606, the decision information generating section 105 generates decision information with a value “1”. In Step S607, the management file generating section 106 generates thumbnail information including decision information and related information. Then, in Step S608, under the control of the writing control section 115, the management file generating section 106 generates APP1 including the related information and the writing section 119 writes a still picture data file including the APP1 and still picture data.

In Step S609 on the other hand, the decision information generating section 105 generates decision information with a value “0” and the management file generating section 106 generates alternative information to find the storage location of the related information. In the next step S610, the management file generating section 106 generates thumbnail information including the decision information and alternative information. In this case, the related information including the thumbnail picture data is stored only in the still picture data file. Then, in Step S611, under the control of the writing control section 115, the writing section 119 writes the still picture data file. It should be noted that the “still picture data file” includes herein both the file of the still picture data that has been generated by the data processor 10 in Step S603 described above and the still picture data file generated by an external unit and acquired in Step S604.

In Step S612, under the control of the writing control section 115, the writing section 119 writes the management file on the optical disk 131.

In the recording processing of this preferred embodiment, the values of the decision information of the thumbnail information shown in FIGS. 4(a) and 4(b) are changed according to the data size of the related information and it is also determined by the data size of the related information whether the information to be stored is the related information or the alternative information. That is to say, if the related information has a data size of 12 KB or less, the related information is stored along with the decision information as in the example shown in FIG. 4(a). On the other hand, if the data size of the related information exceeds 12 KB, then the alternative information is stored along with the decision information as in the example shown in FIG. 4(b).

The related information with a data size exceeding 12 KB is not included in the thumbnail information but is stored only in the still picture data file. Thus, compared to the recording processing of the first preferred embodiment, the redundancy of the contents stored on the storage medium can be further cut down.

Also, according to this preferred embodiment, as a result of the compression and encoding done by the encoded data generating section 101, the data size of the thumbnail picture data increases. That is why even if the data size of the related information increases, the data size of the thumbnail information does not increase. Consequently, it does not take more than a required amount of time to access the thumbnail information and a list of thumbnail pictures can still be presented quickly enough.

In the preferred embodiments described above, the still picture file is supposed to be a DCF basic file. However, this is just an example and a still picture file in any other format may also be used instead. Also, the management files are supposed to include the entry management file 31 and the thumbnail management file 32. Alternatively, these files may be combined into a single file. Conversely, more management files may be provided according to the number of still picture files. The data structures of the entry management file 31 and thumbnail management file 32 shown in FIGS. 3 and 4 are just examples. Thus, any other data structure may be adopted, too.

In the preferred embodiments described above, the data processor is supposed to have both the recording and playback functions alike. However, the data processor may also be designed so as to realize only one of these two functions. For example, if the data processor 10 is designed as a player that has only the playback function, then the player can present a list of thumbnail pictures by analyzing the entry management file 31 and thumbnail management file 32 and reading the related information and/or alternative information.

The recording and playback functions of the data processor are realized by executing a computer program that defines the processing procedure shown in FIG. 2, 5 or 6. By executing such a computer program, a computer including the data processor operates the respective components of the data processor and performs the processing described above. The computer program may be circulated on the market by being stored on a storage medium such as a CD-ROM or downloaded over telecommunications lines such as the Internet. As a result, even a computer system can also operate as a recorder and/or player with the same functions as the data processor described above.

### INDUSTRIAL APPLICABILITY

According to the present invention, the capacity consumed by the data stored in multiple locations can be cut down significantly. In addition, data related to the contents of a given content, such as thumbnail picture data, can be accessed easily and quickly.

1. A data processor comprising:
a first receiving section for receiving a first signal to acquire a first data file including a first data concerning video and/or audio and a first piece of related information showing contents of the first data;
a second receiving section for receiving a second signal representing video and/or audio;
a data generating section for generating a second data concerning the video and/or the audio based on the second signal;
a processing section for generating link information showing a location of the first piece of related information in the first data file, in response to the first signal and for generating a second piece of related information, showing contents of the second data, in response to the second signal;
a decision section for generating a different piece of decision information according to a type of the signal received;
a management file generating section for generating a management file, including the decision information and the link information, for the first data; and
a writing section for writing the management file on a storage medium and also writing either the first data file or a second data file on the storage medium, the second data file including the second piece of related information and the second data.

2. The data processor of claim 1, wherein the decision section generates a different piece of decision information depending on whether the signal received is the first signal or the second signal, and
wherein the management file generating section generates a management file, including the decision information and the second piece of related information, for the second data, when the decision information shows that the received signal is the second signal, and
wherein the writing section writes the management file on the storage medium.

3. The data processor of claim 1, wherein the processing section generates, as the link information, at least one of information identifying the first data file, an offset from the top of the first data file to the first piece of related information, and the size of the first piece of related information.

4. The data processor of claim 1, wherein the first receiving section acquires the first data concerning the video and the first piece of related information including thumbnail data of the video, based on the first data file.

5. The data processor of claim 4, wherein the first receiving section acquires, based on the first data file, either the first data concerning a still picture and the first piece of related information including thumbnail data of the still picture, or the first data concerning a moving picture and the first piece of related information including thumbnail data of one picture of the moving picture.

6. The data processor of claim 1, wherein the second receiving section receives the second signal representing the video and the processing section generates the second piece of related information including thumbnail data of the video.

7. The data processor of claim 6, wherein the processing section generates either the second piece of related information including thumbnail data of a still picture or the second piece of related information including thumbnail data of one picture of a moving picture.

8. The data processor of claim 1, wherein the first receiving section acquires the first data concerning the audio and the first piece of related information including thumbnail data showing identity as audio based on the first data file.

9. A data processing method comprising the steps of:
receiving a first signal to acquire a first data file including a first data concerning video and/or audio and a first piece of related information showing contents of the first data;
receiving a second signal representing video and/or audio;
generating a second data concerning the video and/or the audio based on the second signal;
generating link information showing a location of the first piece of related information in the first data file, in response to the first signal and generating a second piece of related information, showing contents of the second data, in response to the second signal;
generating a different piece of decision information according to a type of the signal received;
generating a management file, including the decision information and the link information, for the first data; and
writing the management file on a storage medium and also writing either the first data file or a second data file on the storage medium, the second data file including the second piece of related information and the second data.

10. The data processing method of claim 9, wherein the step of generating the decision information includes generating a different piece of decision information depending on whether the signal received is the first signal or the second signal, and
wherein the step of generating the management file includes generating a management file, including the decision information and the second piece of related information, for the second data, when the decision information shows that the received signal is the second signal, and
wherein the step of writing includes writing the management file on the storage medium.

11. The data processing method of claim 9, wherein the step of generating the second piece of related information includes generating, as the link information, at least one of information identifying the first data file, an offset from the top of the first data file to the first piece of related information, and the size of the first piece of related information.

12. The data processing method of claim 9, wherein the step of acquiring the first data file includes acquiring the first data concerning the video and the first piece of related information, including thumbnail data of the video, based on the first data file.

13. The data processing method of claim 12, wherein the step of acquiring the first data file includes acquiring, based on the first data file, either the first data concerning a still picture and the first piece of related information, including thumbnail data of the still picture, or the first data concerning a moving picture and the first piece of related information including thumbnail data of one picture of the moving picture.

14. The data processing method of claim 9, wherein the step of receiving the second signal includes receiving the second signal representing the video and wherein the step of generating the second piece of related information includes generating the second piece of related information including thumbnail data of the video.

15. The data processing method of claim 14, wherein the step of generating the second piece of related information includes generating either the second piece of related information including thumbnail data of a still picture or the second piece of related information including thumbnail data of one picture of a moving picture.

16. The data processing method of claim 9, wherein the step of acquiring the first data file includes acquiring the first data concerning the audio and the first piece of related information, including thumbnail data showing identity as audio based on the first data file.
